(19) United States
(12) Patent Application Publication
(10) Pub. No.: US 2025/0291239 A1
(43) Pub. Date: Sep. 18, 2025

(54) Projection device

(71) Applicant: Coretronic Corporation, Hsin-Chu (TW)

(72) Inventors: CHUN-HSIN LU, Hsin-Chu (TW); JEN-WEI KUO, Hsin-Chu (TW); WEN-CHIEH CHUNG, Hsin-Chu (TW); WEN-CHUN WANG, Hsin-Chu (TW)

(21) Appl. No.: 18/789,746

(22) Filed: Jul. 31, 2024

(30) Foreign Application Priority Data
Mar. 12, 2024 (CN) 202410276047.4

(51) Int. Cl. G03B 21/20; G02B 26/00

(52) U.S. Cl. CPC G03B 21/204; G02B 26/008; G03B 21/2066; G03B 21/208

(57) ABSTRACT

The disclosure provides a projection device, including a lighting system, a light valve assembly, and a projection lens. The lighting system includes a light source module, a first light path adjustment element, a light combining and splitting element, a wavelength conversion assembly, and a second light path adjustment element. The light source module provides a light source beam along a first direction. The first light path adjustment element transmits the light source beam along a second direction. The light combining and splitting element is disposed on a transmission path of the light source beam. The wavelength conversion assembly converts the light source beam into a conversion light beam transmitted to the light combining and splitting element. The light combining and splitting element transmits the conversion light beam along a third direction. The second light path adjustment element transmits the conversion light beam along a fourth direction.

### CROSS-REFERENCE TO RELATED APPLICATION

This application claims the priority benefit of China Application No. 202410276047.4, filed on Mar. 12, 2024. The entirety of the above-mentioned patent application is hereby incorporated by reference herein and made a part of this specification.

### FIELD OF THE DISCLOSURE

The disclosure relates to a display device, and more particularly to a projection device.

### BACKGROUND OF THE DISCLOSURE

In recent years, the technology of projection devices has become increasingly mature, and the occasions for using a projection device have become more diverse, extending from classrooms and conference rooms to various settings such as home environments. Therefore, the demand for lightweight and portable projection devices has gradually increased. However, the optical path design of the configuration of known projection devices makes it difficult to reduce the size of the projection device.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE DISCLOSURE

A projection device according to an embodiment of the disclosure includes a lighting system, a light valve assembly, and a projection lens. The lighting system includes a light source module, a first light path adjustment element, a light combining and splitting element, a wavelength conversion assembly, and a second light path adjustment element. The light source module is configured to provide a light source beam along a first direction. The first light path adjustment element is disposed on a transmission path of the light source beam and configured to transmit the light source beam along a second direction, the first direction being not parallel to the second direction. The light combining and splitting element is disposed on the transmission path of the light source beam along the second direction. The wavelength conversion assembly is disposed on the transmission path of the light source beam passing through the light combining and splitting element. The wavelength conversion assembly is configured to convert part of the light source beam into a conversion light beam with a different wavelength and to transmit the conversion light beam to the light combining and splitting element, and the light combining and splitting element transmits the conversion light beam along a third direction, the third direction being not parallel to the first direction and the second direction. The second light path adjustment element is disposed between the light combining and splitting element and the light valve assembly and is configured to transmit the conversion light beam to the light valve assembly along a fourth direction, and an included angle between the fourth direction and the second direction is greater than 135 degrees and less than 180 degrees. The light valve assembly is configured to convert the conversion light beam into an image light beam and to transmit the image light beam to the projection lens.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a projection device according to an embodiment of the disclosure;

FIG. 2A is a schematic diagram of a projection device according to an embodiment of the disclosure;

FIG. 2B is a schematic diagram of a projection device according to an embodiment of the disclosure;

FIG. 3 is a partial cross-sectional schematic diagram of a projection device along axis Z according to an embodiment of the disclosure;

FIG. 4 is a schematic diagram of a wavelength selection element according to an embodiment of the disclosure;

FIG. 5 is a partial schematic diagram of the embodiment of FIG. 2B;

FIG. 6 is a schematic top view of a projection device according to another embodiment of the disclosure;

FIG. 7 is a partial schematic diagram of the embodiment of FIG. 6;

FIG. 8 is a schematic top view of a projection device according to another embodiment of the disclosure;

FIG. 9 is a schematic top view of a projection device according to another embodiment of the disclosure;

FIG. 10 is a schematic top view of a projection device according to another embodiment of the disclosure;

FIG. 11 is a schematic top view of a projection device according to another embodiment of the disclosure;

FIG. 12 is a schematic top view of a projection device according to another embodiment of the disclosure;

FIG. 13 is a schematic top view of a projection device according to another embodiment of the disclosure;

FIG. 14 is a schematic top view of a projection device according to another embodiment of the disclosure;

FIG. 15 is a schematic diagram of a light combining and splitting element according to another embodiment of the disclosure; and

FIG. 16 is a schematic diagram of a light combining and splitting element according to another embodiment of the disclosure.

### DETAILED DESCRIPTION OF PREFERRED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a projection device that can reduce the size of the projection device.

Other advantages and objects of the disclosure may be further illustrated by the technical features broadly embodied and described as follows.

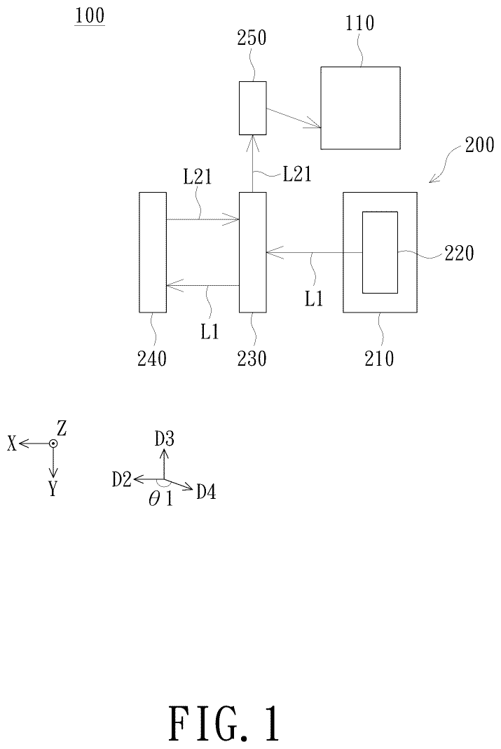

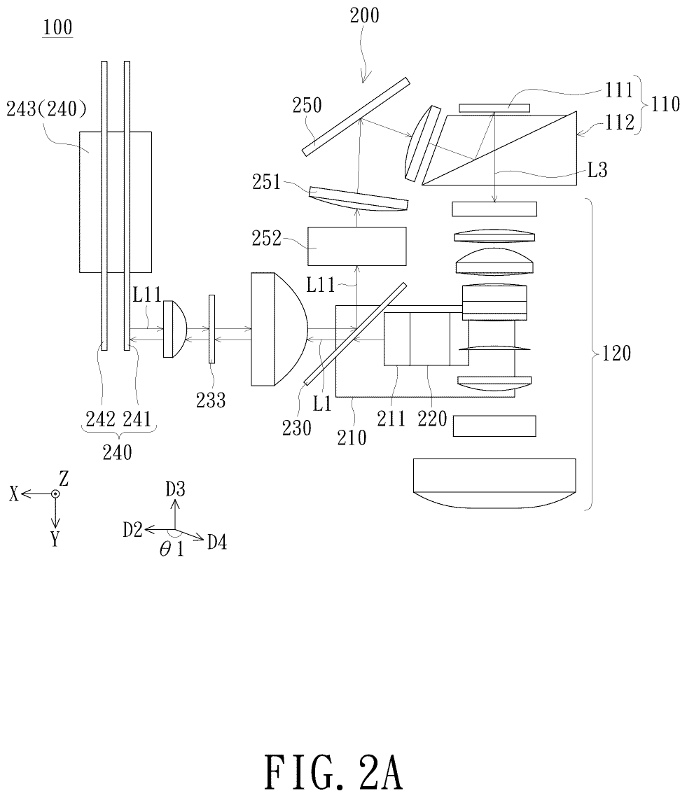

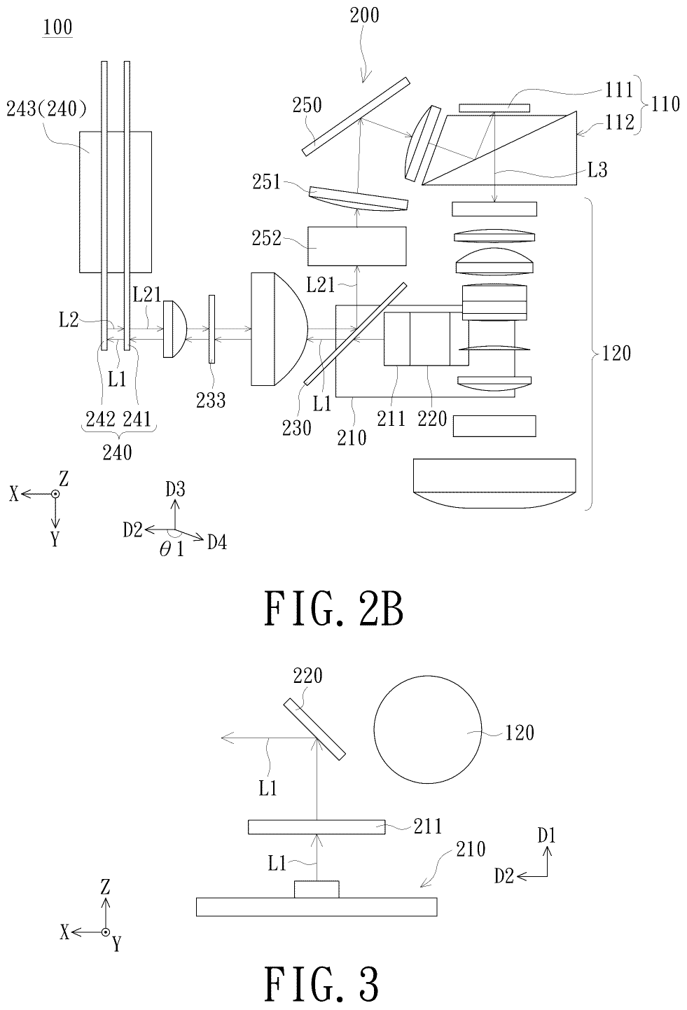

FIG. 1 is a schematic diagram of a projection device according to an embodiment of the disclosure. FIG. 2A is a schematic diagram of a projection device according to an embodiment of the disclosure. FIG. 3 is a partial cross-sectional schematic diagram of a projection device along axis Z according to an embodiment of the disclosure. Axis X, axis Y, and axis Z, for example, are perpendicular to each other, and the projection lens is omitted in FIG. 1. Please refer to FIG. 1 and FIG. 3. A projection device 100 according to an embodiment of the disclosure includes a lighting system 200, a light valve assembly 110, and a projection lens 120. The lighting system 200 includes a light source module 210, a first light path adjustment element 220, a light combining and splitting element 230, a wavelength conversion assembly 240, and a second light path adjustment element 250. The light source module 210 is configured to provide a light source beam L1 along a first direction D1. The light source module 210, for example, includes a light source element for providing the light source beam L1 and a circuit board for arranging the light source element (excluding a heat dissipation element, such as a heat pipe or a fin heat sink). The light source element, for example, is a light emitting diode (LED) or a laser diode (LD). The light source beam L1, for example, is a blue excitation beam (laser beam, with a dominant wavelength of the light source beam L1 being, for example, 455 nm), but the disclosure does not specifically limit the type and color of the light source element for the light source beam L1. The first light path adjustment element 220 is disposed on the transmission path of the light source beam L1 and is configured to transmit the light source beam L1 along a second direction D2, wherein the first direction D1 is not parallel to the second direction D2. Specifically, the first direction D1 is, for example, parallel to axis Z, and the second direction D2 is, for example, parallel to axis X. In an embodiment, the included angle between the first direction D1 and the second direction D2 is between 75 degrees and 105 degrees. The first light path adjustment element 220 changes a transmission direction of the light source beam L1 from the first direction D1 to the second direction D2. For example, as shown in FIG. 2A, the first light path adjustment element 220 is, for example, a reflective element. The light source beam L1 is, for example, transmitted upward from the bottom of the projection device 100 to the first light path adjustment element 220. Therefore, when the projection device 100 is viewed from above (as shown in FIG. 1 and FIG. 2A), the light source beam L1 transmitted along the first direction D1 is not visible due to the shielding by the first light path adjustment element 220.

Based on the foregoing description, the light combining and splitting element 230 is disposed on the transmission path of the light source beam L1 along the second direction D2. The wavelength conversion assembly 240 is disposed on the transmission path of the light source beam L1 passing through the light combining and splitting element 230. In this embodiment, the light combining and splitting element 230 is, for example, a polarized coating beam splitter, which allows the light source beam L1 (for example, linearly polarized light, wavelength in a range of 440 nm˜470 nm) to pass through or be reflected based on its polarization state, and reflects visible light with the wavelength different from that of the light source beam L1. In this embodiment, the light source beam L1 transmitted along the second direction D2 passes through the light combining and splitting element 230 and is transmitted to the wavelength conversion assembly 240. The wavelength conversion assembly 240 in this embodiment is configured to convert at least part of the light source beam L1 into a conversion light beam L21 with a different wavelength. The wavelength conversion assembly 240 is configured to transmit the conversion light beam L21 to the light combining and splitting element 230. It is worth noting that the conversion light beam L21 is, for example, transmitted from the wavelength conversion assembly 240 to the light combining and splitting element 230 in a direction opposite to the second direction D2 (for example, being incident to the light combining and splitting element 230 in a direction opposite to the second direction D2), thereby reducing the size of the projection device 100. The light combining and splitting element 230 transmits the conversion light beam L21 along a third direction D3 (that is to say, a transmission direction in which the beam leaves the light combining and splitting element 230). The third direction D3 is not parallel to the first direction D1 or the second direction D2. Specifically, the third direction D3 is, for example, parallel to axis Y. It is particularly noted that the transmission direction of the conversion light beam L21 is, for example, the transmission direction of the main beam of the conversion light beam L21.

Continue to refer to FIG. 1. In an embodiment of the disclosure, the second light path adjustment element 250 is disposed between the light combining and splitting element 230 and the light valve assembly 110, and is configured to transmit the conversion light beam L21 from the light combining and splitting element 230 to the light valve assembly 110 along a fourth direction D4. An included angle θ1 between the fourth direction D4 and the second direction D2 is greater than 135 degrees and less than 180 degrees. For example, as shown in FIG. 2A, the second light path adjustment element 250 is, for example, a reflective element, and transmits the conversion light beam L21 along the fourth direction D4. The light valve assembly 110 is configured to convert the conversion light beam L21 into an image light beam L3 (shown in FIG. 2A) and to transmit the image light beam L3 to the projection lens 120 (as shown in FIG. 2A). The transmission direction of the image light beam L3 is, for example, opposite to the third direction D3, or the included angle between them is greater than 165 degrees and less than 180 degrees, thus reducing the size of the projection device 100, but the disclosure is not limited thereto. Based on the above description, the transmission path of light is folded through the configuration of the lighting system 200 in an embodiment of the disclosure, so the light source module 210 can be disposed below the projection lens 120, as shown in FIG. 2A and FIG. 3. That is, a projection region of the light source module 210 on a plane perpendicular to the first direction D1 overlaps at least partially with a projection region of the projection lens 120 on the plane perpendicular to the first direction D1.

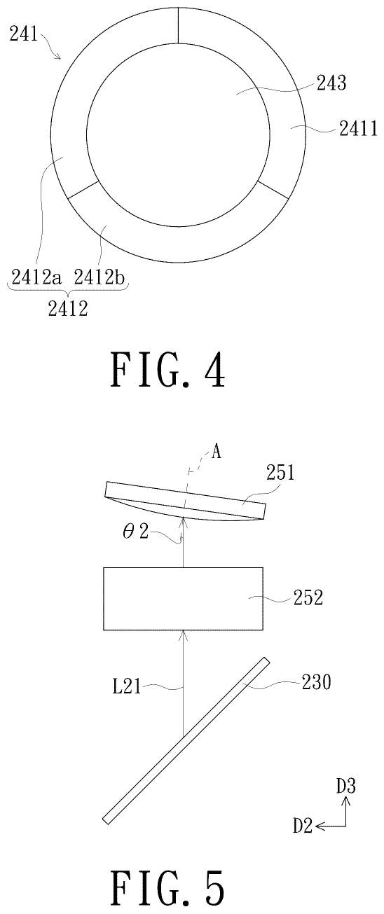

FIG. 2B is a schematic diagram of a projection device according to an embodiment of the disclosure. FIG. 4 is a schematic diagram of a wavelength selection element according to an embodiment of the disclosure. Please refer to FIG. 2A, FIG. 2B, and FIG. 4. In this embodiment, the lighting system 200, for example, sequentially provides the light source beam L1 (would be labeled L11 in the following description) and the conversion light beam L21 to the light valve assembly 110. Furthermore, during the time when the conversion light beam L21 is provided to the light valve assembly 110, the wavelength conversion assembly 240 is configured to convert at least part of the light source beam L1 into a conversion light beam L21 with a different wavelength, and then to transmit the conversion light beam L21 to the light combining and splitting element 230. During the time when the light source beam L11 is provided to the light valve assembly 110, the light source beam L1 is not converted into a conversion light beam by the wavelength conversion assembly 240, but is directly transmitted to the light combining and splitting element 230. The light source beam L11 is transmitted along the third direction D3 by the light combining and splitting element 230, and its subsequent transmission path is, for example, the same as that of the conversion light beam L21. The transmission path of the light source beam L11 is shown in FIG. 2A, and the transmission path of the conversion light beam L21 is shown in FIG. 2B. Specifically, the wavelength conversion assembly 240, for example, includes a wavelength selection element 241 and a wavelength conversion element 242. The wavelength selection element 241 is, for example, disposed between the wavelength conversion element 242 and the light combining and splitting element 230. The wavelength conversion assembly 240, for example, further includes a drive element 243 which is, for example, connected to the wavelength selection element 241 and the wavelength conversion element 242 that are stacked. The drive element 243 is, for example, configured to drive the wavelength selection element 241 and the wavelength conversion element 242 to rotate synchronously.

The wavelength selection element 241, for example, has a reflection zone 2411 and a wavelength selection zone 2412. The reflection zone 2411 and the wavelength selection zone 2412 enter the transmission path of the light source beam L1 at different points in time (i.e., the reflection zone 2411 and the wavelength selection zone 2412 are located on the transmission path of the light source beam L1 at different points in time). The reflection zone 2411 is, for example, configured to reflect the light source beam L1 (that is, the light source beam L11 is reflected by the reflection zone 2411) during the time when the light source beam L11 is provided to the light valve assembly 110, and the reflection zone 2411 is configured to transmit the light source beam L11 sequentially to the light combining and splitting element 230 and the light valve assembly 110.

The wavelength conversion element 242, for example, converts the light source beam L1 passing through the wavelength selection zone 2412 into a conversion light beam L2, and at least part of the conversion light beam L2 passes through the wavelength selection zone 2412 to generate the conversion light beam L21 (during the time when the conversion light beam L21 is provided to the light valve assembly 110). Specifically, the wavelength conversion element 242, for example, includes phosphor. When the light source beam L1 is transmitted to the wavelength conversion element 242, it excites the phosphor to generate a conversion light beam L2 which is, for example, yellow light. However, the disclosure does not specifically limit the wavelength of the conversion light beam.

In an embodiment of the disclosure, the wavelength selection zone 2412 includes, for example, multiple different wavelength selection sub-zones. Since at least part of the conversion light beam L2 passes through the different wavelength selection sub-zones in time sequence, the conversion light beam L2 is converted into multiple conversion light beams with different wavelengths in time sequence. For example, the wavelength selection zone 2412 in FIG. 4 includes two wavelength selection sub-zones 2412a and 2412b, sequentially being a red zone (where, for example, red light and blue light pass through, and other wave bands are reflected; for instance, a wave band of a light beam with a wavelength in a range of 480 nm˜590 nm is reflected, and a wave band of a light beam with a wavelength less than or equal to 480 nm and a wave band of a light beam with a wavelength greater than or equal to 590 nm pass through. It is particularly noted that the passage and reflection of light beams are distinguished by, for example, a transmittance of 50%), and a green zone (where, for example, green light and blue light pass through, and other wave bands are reflected; for instance, a wave band of a light beam with a wavelength greater than 610 nm is reflected, and a wave band of a light beam with a wavelength less than or equal to 610 nm passes through). Hence, the multiple conversion light beams are, for example, red light and green light, but the disclosure is not specifically limited thereto. In the following description, the conversion light beam L21 will be used to refer to the multiple conversion light beams, which have passed through the wavelength selection zone 2412, generated in time sequence.

Following the above, the lighting system 200 of the projection device 100 further includes, for example, a quarter-wave plate 233 disposed between the light combining and splitting element 230 and the wavelength conversion assembly 240. Since the light source beam L1 from the light combining and splitting element 230 first passes through the quarter-wave plate 233, and the light source beam L11 reflected by the reflection zone 2411 passes through the quarter-wave plate 233 again, the light source beam L11 that has passed through the quarter-wave plate 233 again is reflected by the light combining and splitting element 230 and then transmitted along the third direction D3. It should be noted that one or more lenses (for example, lenses with positive diopters) may be optionally disposed between the light combining and splitting element 230 and the wavelength conversion assembly 240 in order to adjust the transmission directions of the light source beam L1 and the light source beam L11 between the light combining and splitting element 230 and the wavelength conversion assembly 240. In addition, since the wavelength of the conversion light beam L21 is different from that of the light source beam L1, the light combining and splitting element 230 also reflects the conversion light beam L21 and transmits the conversion light beam L21 along the third direction D3.

The light valve assembly 110 includes, for example, a light valve 111 and a prism assembly 112. The light valve 111 is, for example, a digital micromirror device (DMD), but the disclosure is not specifically limited thereto. Moreover, in an embodiment of the disclosure, the lighting system 200 further includes, for example, a diffusion sheet 211 disposed between the light source module 210 and the first light path adjustment element 220. The diffusion sheet 211 is configured to adjust the shape of light spot of the light source beam L1, so the shape of light spot of the light source beam L11 subsequently transmitted to the light valve 111 approximates the active surface of the light valve 111, but the disclosure is not limited thereto.

FIG. 5 is a partial schematic diagram of the embodiment of FIG. 2B. Please refer to FIG. 2B and FIG. 5. In an embodiment of the disclosure, the lighting system 200 further includes, for example, an optical path difference compensation element 251 which is disposed, for example, between the light combining and splitting element 230 and the second light path adjustment element 250. The optical path difference compensation element 251 is, for example, a lens. There is a tilt angle θ2 between the optical axis A of the optical path difference compensation element 251 and the third direction D3, and the tilt angle θ2 is, for example, between 2 degrees and 30 degrees. Specifically, when the conversion light beam L21 is transmitted to the light valve 111 of the light valve assembly 110, the transmission paths of the light beams transmitted to two sides opposite to each other of the active surface of the light valve 111 may differ. Therefore, the optical path difference compensation element 251 can be used to compensate for the optical path difference. The optical path difference compensation element 251 is, for example, a spherical lens, but the disclosure is not specifically limited thereto. In addition, in an embodiment of the disclosure, the lighting system 200 may further include a light homogenizing element 252 disposed, for example, between the optical path difference compensation element 251 and the light combining and splitting element 230. The light homogenizing element 252 may be a microlens array, but the disclosure is not specifically limited thereto. It should be noted that the transmission path of the conversion light beam L21 between the light combining and splitting element 230 and the optical path difference compensation element 251 is as shown in FIG. 5. The transmission path of the light source beam L11 is the same as that of the conversion light beam L21 and is not elaborated herein.

Thus, in this embodiment, the transmission path of light is folded through the configuration of the lighting system 200, including: (1) using the first light path adjustment element 220 to change the transmission direction of the light source beam L1, (2) transmitting the light source beam L1 along the second direction D2 substantially back and forth, and converting the light source beam L1 into the conversion light beam L2, (3) using the second light path adjustment element 250 to change the transmission direction of the light source beam L11 and the conversion light beam L21, thereby making the transmission direction of the image light beam L3 anti-parallel to the third direction D3 or the included angle therebetween greater than 165 degrees and less than 180 degrees, thereby reducing the size of the projection device 100.

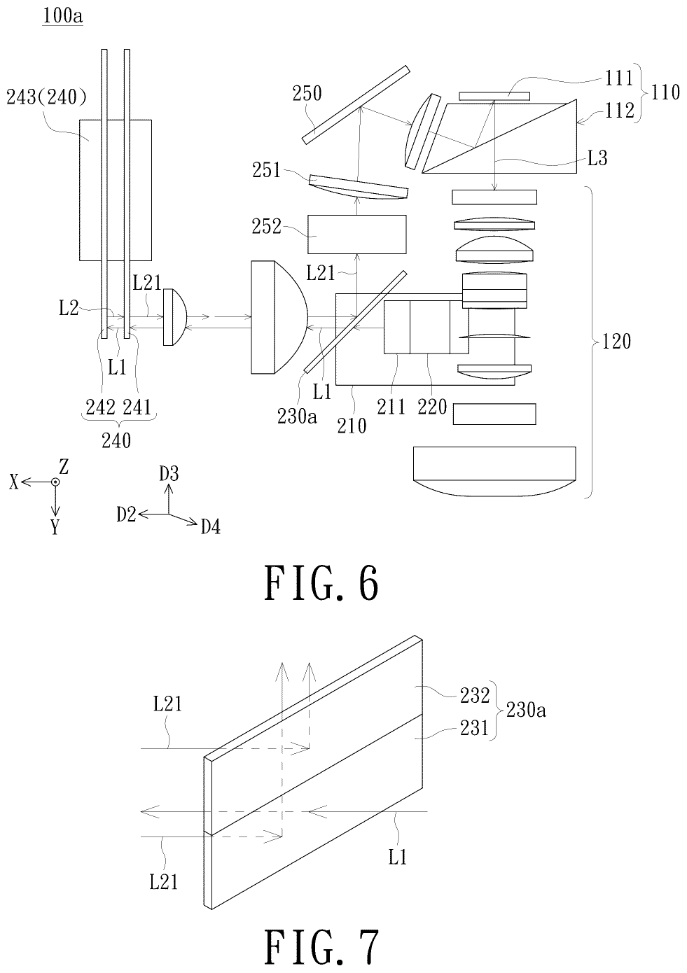

FIG. 6 is a schematic top view of a projection device according to another embodiment of the disclosure. FIG. 7 is a partial schematic diagram of the embodiment of FIG. 6. Please refer to FIG. 6 and FIG. 7. A projection device 100a in FIG. 6 is similar to the projection device 100 in FIG. 2B, with one of the main differences being the light combining and splitting element. In the embodiment of the projection device 100a, the transmission path of the conversion light beam L21 is as shown in FIG. 6, and the transmission path of the light source beam L11 is as shown in FIG. 2A. Specifically, in this embodiment, the light combining and splitting element 230a includes, for example, a first optical portion 231 and a second optical portion 232. The first optical portion 231 is configured to, for example, allow the light source beam L1 to pass through, and the first optical portion 231 is configured to reflect the conversion light beam L21. The second optical portion 232 is configured to, for example, reflect the light source beam L11 (not shown in the figure) and the conversion light beam L21. Specifically, during the time when the conversion light beam L21 is provided according to an embodiment of the disclosure, the light source beam L1 transmitted along the second direction D2 to the light combining and splitting element 230a is, for example, transmitted to the first optical portion 231 and passes through the first optical portion 231. The conversion light beam L21 is, for example, transmitted to the first optical portion 231 and the second optical portion 232 of the light combining and splitting element 230a, and then reflected by the first optical portion 231 and the second optical portion 232. In another embodiment, the light combining and splitting element further includes a reflecting mirror. The first optical portion 231 is configured to, for example, enable the light source beam L11 to partially pass through and to be partially reflected, and the first optical portion 231 is, for example, configured to reflect the conversion light beam L21. The second optical portion 232 can allow the light source beam L1 to pass through and allow the conversion light beam L21 to be reflected. The light source beam L11 that has penetrated the first optical portion 231 is transmitted to the second light path adjustment element 250 (through the second optical portion 232) by the reflecting mirror. It is worth mentioning that the projection device 100a in this embodiment may be provided without the quarter-wave plate in the projection device 100 (as shown in FIG. 2A), but the disclosure is not limited thereto. It is worth noting that in this embodiment, the light source beam L1, for example, is transmitted obliquely to pass through the first optical portion 231. Therefore, the light homogenizing element 252 is used to homogenize the beam (light source beam L11 and conversion light beam L21) to reduce the problem of oblique incidence. In this embodiment, the light homogenizing element 252 is, for example, a microlens array, which helps to reduce the size of the projection device 100a.

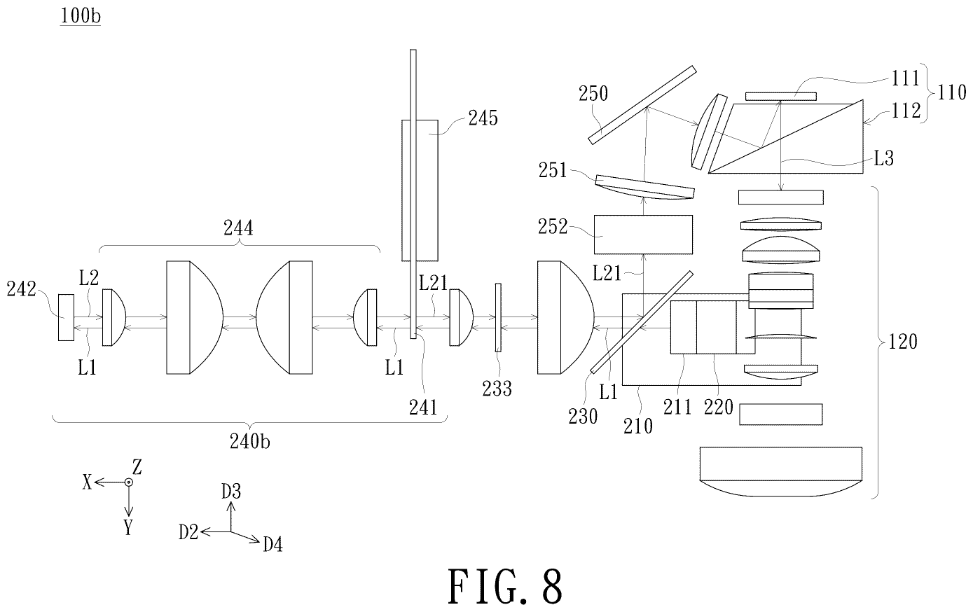

FIG. 8 is a schematic top view of a projection device according to another embodiment of the disclosure. Please refer to FIG. 8. A projection device 100b in FIG. 8 is similar to the projection device 100 in FIG. 2B, with the main difference being the wavelength conversion assembly. In the embodiment of the projection device 100b, the transmission path of the conversion light beam L21 is as shown in FIG. 8, and the transmission path of the light source beam L11 is as shown in FIG. 2A. Specifically, in this embodiment, the wavelength selection element 241 and the wavelength conversion element 242 may be spaced apart. For example, the wavelength conversion assembly 240b further includes, for example, a lens assembly 244. The lens assembly 244, for example, is disposed between the wavelength selection element 241 and the wavelength conversion element 242. The lens assembly 244 includes, for example, four conjugate lenses for extending the transmission path of the light source beam L1 from the wavelength selection element 241 and focusing the light source beam L1 on the wavelength conversion element 242. The drive element (a first drive element 245) is configured to, for example, drive the wavelength selection element 241 to rotate. In this embodiment, the wavelength conversion element 242 is, for example, a static element, but the disclosure is not limited thereto.

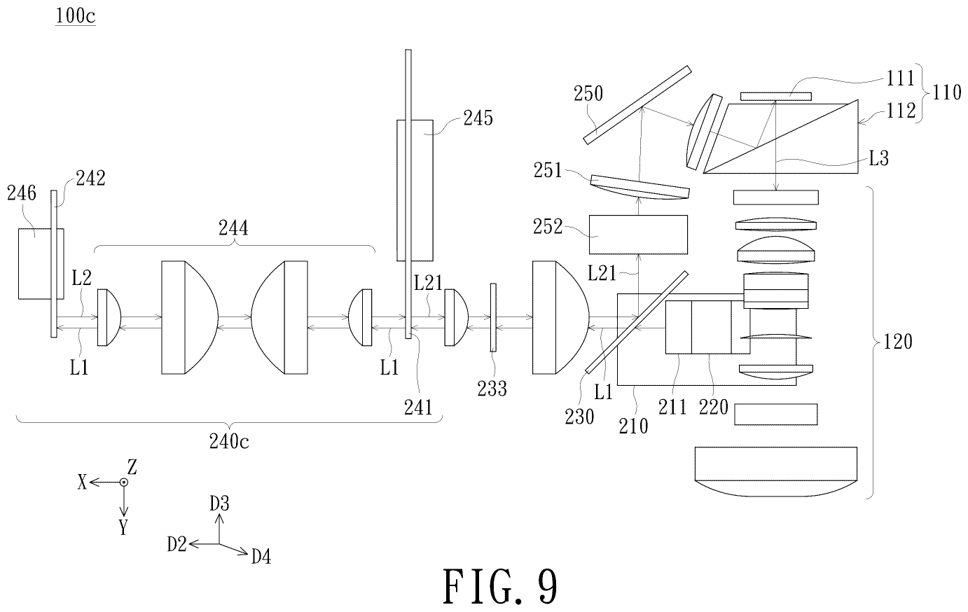

FIG. 9 is a schematic top view of a projection device according to another embodiment of the disclosure. Please refer to FIG. 9. The projection device 100b in FIG. 8 is similar to a projection device 100c in FIG. 9, with the main difference of the wavelength conversion assembly 240c further including, for example, a second drive element 246 for driving the wavelength conversion element 242 to rotate. In the embodiment of the projection device 100c, the transmission path of the conversion light beam L21 is as shown in FIG. 9, and the transmission path of the light source beam L11 is as shown in FIG. 2A.

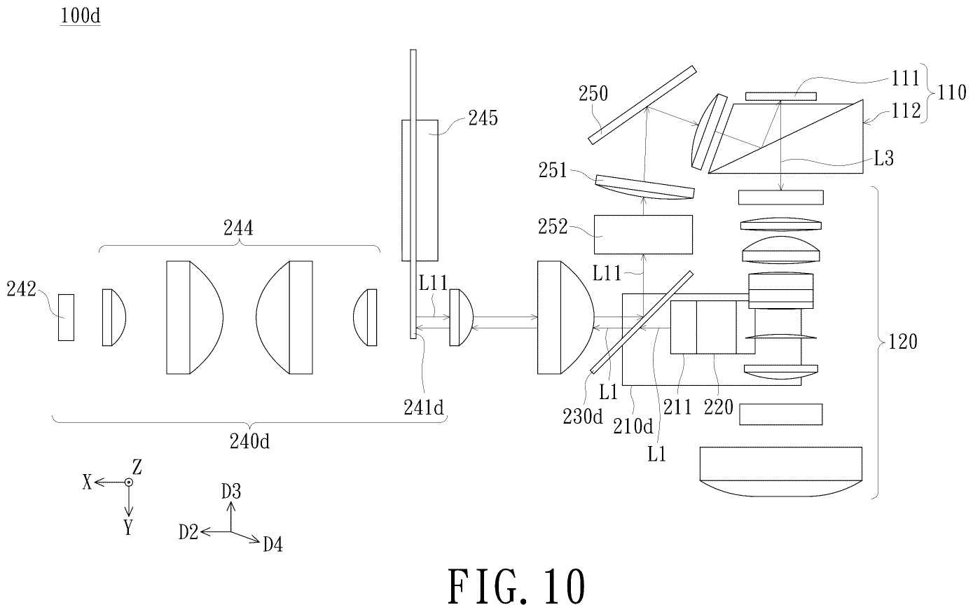

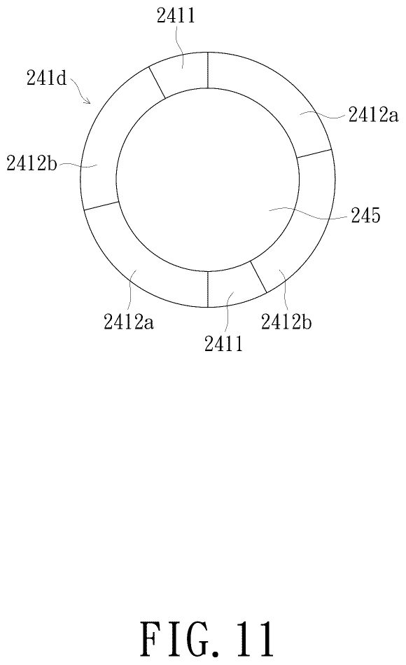

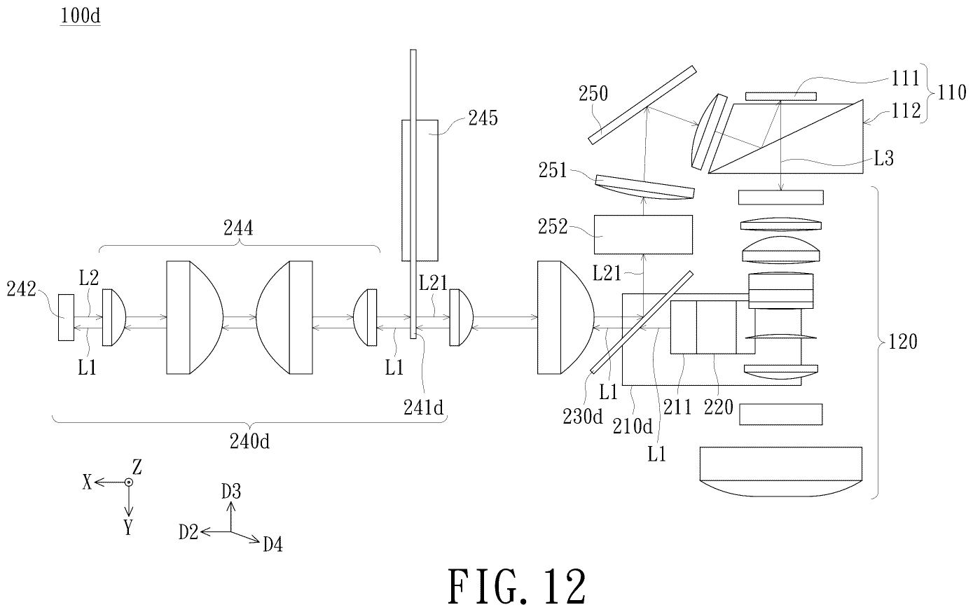

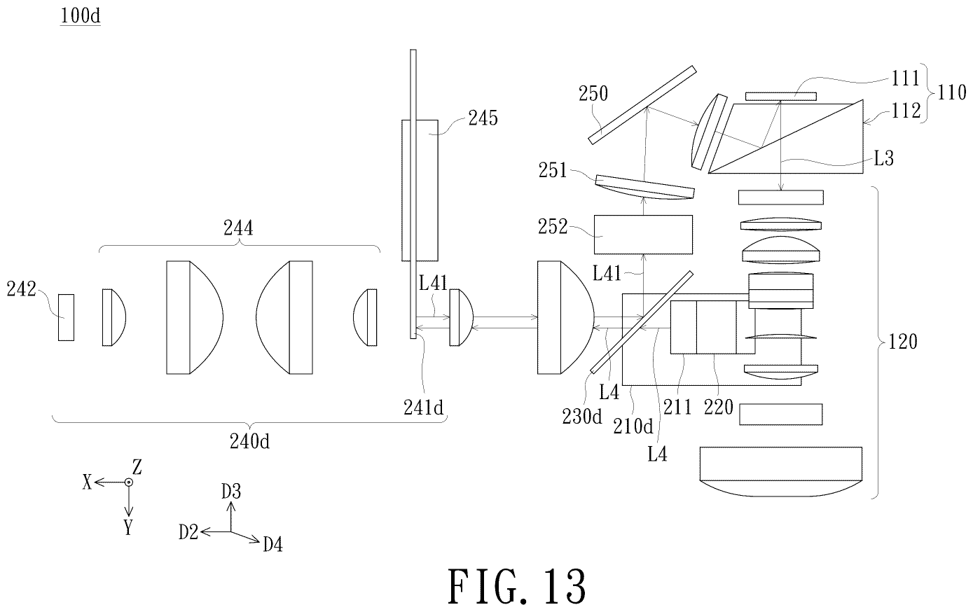

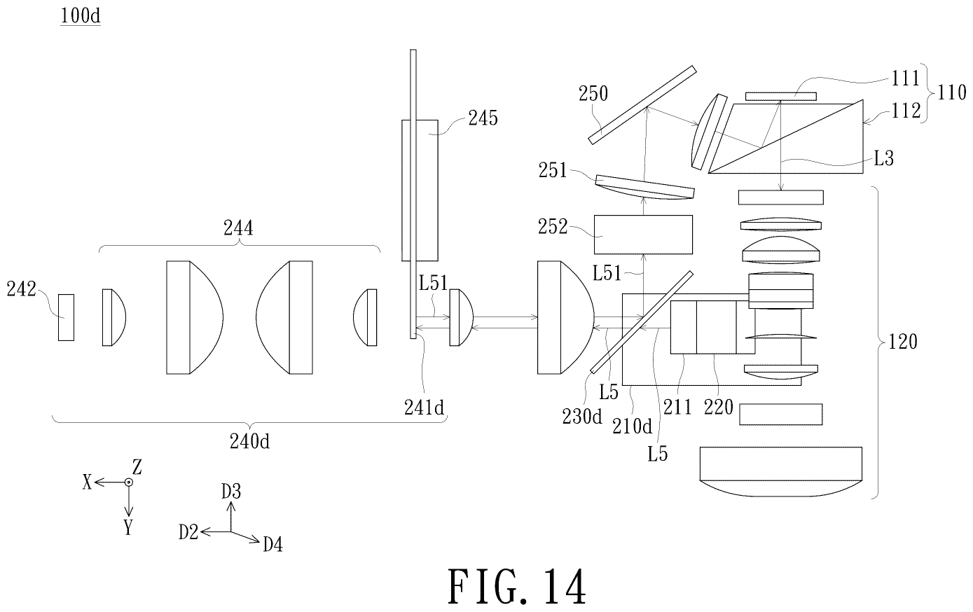

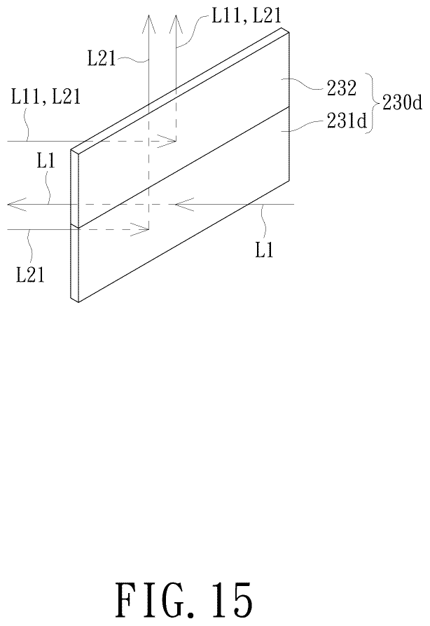

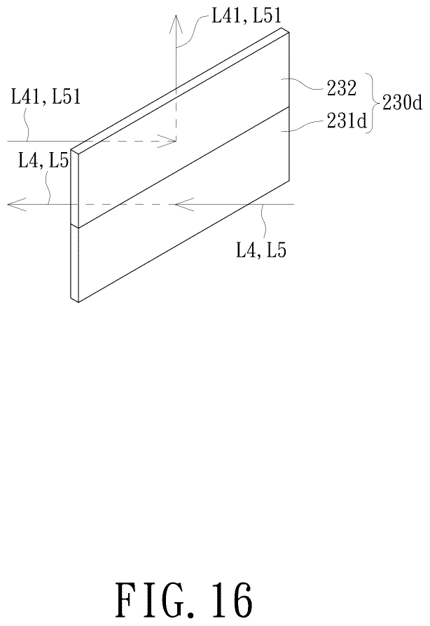

FIG. 10 is a schematic top view of a projection device according to another embodiment of the disclosure. FIG. 11 is a schematic top view of a projection device according to another embodiment of the disclosure. FIG. 12 is a schematic top view of a projection device according to another embodiment of the disclosure. FIG. 13 is a schematic top view of a projection device according to another embodiment of the disclosure. FIG. 14 is a schematic top view of a projection device according to another embodiment of the disclosure. FIG. 15 is a schematic diagram of a light combining and splitting element according to another embodiment of the disclosure. FIG. 16 is a schematic diagram of a light combining and splitting element according to another embodiment of the disclosure. Please refer to FIG. 8 and FIG. 10. The projection device 100d of this embodiment is similar to the projection device 100b in FIG. 8, and the main difference between the projection devices 100d and 100b lies in the light source module 210d, the light combing and splitting element 230d and the wavelength selection element 241d. Specifically, in addition to providing the light source beam L1 along the first direction D1, the light source module 210d of this embodiment further provides an auxiliary light beam along the first direction D1. The light source beam L1 is, for example, a blue excitation beam (a laser beam, with a dominant wavelength of the light source beam L1 being, for example, 449 nm˜461 nm). The auxiliary light beam, for example, includes a red excitation beam (a laser beam, with a dominant wavelength of the auxiliary light beam L4 being, for example, 620 nm˜650 nm) and a green excitation beam (a laser beam, with a dominant wavelength of the auxiliary light beam L5 being, for example, 515 nm˜535 nm), as shown in FIG. 13 and FIG. 14, and the details will be provided in the subsequent paragraphs. The disclosure dose not specifically limit the type, quantity and color of the light source element of the auxiliary light beam. In another embodiment, the auxiliary light beam provided by the light source module 210d may only include the red auxiliary light beam L4.

The light source module 210d of the projection device 100d of this embodiment, for example, continues providing the light source beam L1; during the time when the conversion light beam L21 is provided to the light valve assembly 110, the light source module 210d also provides the auxiliary light beam whose color corresponds to that of the conversion light beam L21. For example, when the conversion light beam L21 is red, the light source module 210d simultaneously provides the auxiliary light beam L4 that is also red (as shown in FIG. 13); similarly, when the conversion light beam L21 is green, the light source module 210d simultaneously provides the auxiliary light beam L5 that is also green (as shown in FIG. 14). Provided with the auxiliary light beams L4, L5, the projection device 100d of this embodiment can have improved color saturation and brightness of the image, with details described below.

The light combing and splitting element 230d of this embodiment is similar to the light combing and splitting element 230a in FIG. 6. The first optical portion 231d of the light combing and splitting element 230d is, for example, configured to let the light source beam L1 pass, and is also configured to let the auxiliary light beams L4 and L5 pass; the first optical portion 231d is configured to reflect the conversion light beam L21, as shown in FIG. 15 and FIG. 16. The second optical portion 232 in this embodiment is, for example, configured to reflect the light source beam L11 and the conversion light beam L21, and is also configured to reflect the auxiliary light beam L41 and the auxiliary light beam L51 which have been reflected by the wavelength selection element 241d, as shown in FIG. 15 and FIG. 16. The quarter-wave plate 233 in the embodiment shown in FIG. 8 can be omitted from the projection device 100d of this embodiment, but the disclosure is not limited thereto. In this embodiment, the light source beam L1, for example, passes through the first optical portion 231d of the light combining and splitting element 230d, and the auxiliary light beams L4 and L5, for example, also pass through the first optical portion 231d of the light combining and splitting element 230d.

In the embodiment of the projection device 100d, during the time when the light source beam L11 is provided to the light valve assembly 110, as shown in FIG. 10, the light source beam L1 passes through the first optical portion 231d of the light combining and splitting element 230d, and then transmits to the reflection zone 2411 of the wavelength selection element 241d (as shown in FIG. 11). The light source beam L11 is the light source beam L1 after being reflected by the reflection zone 2411. The light source beam L11, for example, transmits to the second optical potion 232 of the light combining and splitting element 230d and the light valve assembly 110 sequentially, as shown in FIG. 10 and FIG. 15, while the details are as described above and will not be repeated herein.

Following the above, in the embodiment of the projection device 100d, during the time when the conversion light beam L21 is provided to the light valve assembly 110, the light source module 210d, for example, provides the light source beam L1 and the auxiliary light beam simultaneously (the transmission path of the light source beam L1 is as shown in FIG. 12, and the transmission path of the auxiliary light beam is as shown in FIG. 13 or FIG. 14). At least part of the conversion light beam L2 will pass through different wavelength selection sub-zones in time sequence, and thus will be converted into conversion light beams L21 having different wavelengths in time sequence. Please refer to FIG. 11 and FIG. 12. The wavelength selection element 241d of this embodiment is, for example, provided with two reflection zones 2411, and four wavelength selection zones. The two reflection zones 2411 are, for example, configured relative to each other. The four wavelength selection zones, for example, include two wavelength selection sub-zones 2412a which are configured relative to each other, and two wavelength selection sub-zones 2412b which are configured relative to each other. The wavelength selection sub-zone 2412a is, for example, a red zone (for example, red light and blue light pass through, and other bands are reflected; for instance, a wave band of a light beam with a wavelength in a range of 461 nm˜570 nm and greater than 610 nm is reflected, and a wave band of a light beam with a wavelength in a range of less than 461 nm and in a range between 570 nm and 610 nm passes through. It is particularly noted that the wave band whose wavelength is the same as that of the auxiliary light beam L4 will be reflected.) The wavelength selection sub-zone 2412b is, for example, a green zone (for example, green light and blue light pass through, and other bands are reflected; for instance, a wave band of a light beam with a wavelength in a range of 515 nm˜535 nm and greater than 580 nm is reflected, and a wave band of a light beam with a wavelength in a range of less than 515 nm and in a range between 536 nm and 580 nm passes through. It is particularly noted that the wave band whose wavelength is the same as that of the auxiliary light beam L5 will be reflected.) Other details of the conversion light beam L21 are as described above. Each wavelength selection sub-zone is, for example, configured to reflect the corresponding auxiliary light beam, is configured to let the light source beam L1 pass through, is configured to let a part of the conversion light beam L2 pass through to become the conversion light beam L21, and is configured to reflect (or absorb) another part of the conversion light beam L2. Furthermore, during the time when the conversion light beam L21 which is, for example, red is provided to the light valve assembly 110 (i.e. during the time when the wavelength selection sub-zone 2412a enters the transmission path of the light source beam L1), the light source module 210d, for example, simultaneously provides the auxiliary light beam L4 which is also red. Please refer to FIG. 13 and FIG. 16. Specifically, the auxiliary light beam L4 which is transmitted along the second direction D2 by the first light path adjustment element 220 will pass through the first optical portion 231d of the light combining and splitting element 230d, and transmit to the wavelength selection sub-zone 2412a of the wavelength selection element 241d. The auxiliary light beam L41 is, for example, the auxiliary light beam L4 after being reflected by the wavelength selection sub-zone 2412a. The auxiliary light beam L41, for example, transmits to the second optical portion 232 of the light combining and splitting element 230d and to the light valve assembly 110 sequentially. The subsequent transmission path of the auxiliary light beam is the same as that of the light source beam L11, which is not repeated herein. Hence, the light valve assembly 110 can accept the auxiliary light beam L41 (with the dominant wavelength such as 620 nm˜650 nm) and the conversion light beam L21 (whose wave band corresponds to red light) simultaneously. Similarly, during the time when the conversion light beam L21 whose wave band corresponds to green light (that is, the wavelength selection sub-zone 2412b enters the transmission path of the light source beam L1), the light source module 210d, for example, provides the auxiliary light beam L5 which is also green at the same time. Please refer to FIG. 14 and FIG. 16. The auxiliary light beam L5 passes through the light combining and splitting element 230d and then transmits to the wavelength selection sub-zone 2412b of the wavelength selection element 241d. The auxiliary light beam L51 is, for example, the auxiliary light beam L5 after being reflected by the wavelength selection sub-zone 2412b. The auxiliary light beam L51, for example, transmits to the second optical portion 232 of the light combining and splitting element 230d and the light valve assembly 110 sequentially. The subsequent transmission path of the auxiliary light beam L51 is the same as that of the light source beam L11, which is not repeated herein. Therefore, the light valve assembly 110 can accept the auxiliary light beam L51 (with the dominant wavelength such as 515 nm˜535 nm) and the conversion light beam L21 (whose wave band corresponds to green light) at the same time.

In summary, the projection device of the embodiments of the disclosure folds the transmission path of light through configurations of the first light path adjustment element, the light combining and splitting element, the wavelength conversion assembly, and the second light path adjustment element of the lighting system in order to reduce the size of the projection device.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A projection device, comprising a lighting system, a light valve assembly, and a projection lens, wherein:
the lighting system comprises a light source module, a first light path adjustment element, a light combining and splitting element, a wavelength conversion assembly, and a second light path adjustment element, wherein:
the light source module is configured to provide a light source beam along a first direction;
the first light path adjustment element is disposed on a transmission path of the light source beam and configured to transmit the light source beam along a second direction, the first direction being not parallel to the second direction;
the light combining and splitting element is disposed on the transmission path of the light source beam along the second direction;
the wavelength conversion assembly is disposed on the transmission path of the light source beam passing through the light combining and splitting element and is configured to convert at least part of the light source beam into a conversion light beam with a different wavelength and to transmit the conversion light beam to the light combining and splitting element, and the light combining and splitting element transmits the conversion light beam along a third direction, the third direction being not parallel to the first direction and the second direction; and
the second light path adjustment element is disposed between the light combining and splitting element and the light valve assembly and is configured to transmit the conversion light beam to the light valve assembly along a fourth direction, and an included angle between the fourth direction and the second direction is greater than 135 degrees and less than 180 degrees, and
the light valve assembly is configured to convert the conversion light beam into an image light beam and transmit the image light beam to the projection lens.

2. The projection device according to claim 1, wherein the lighting system further comprises an optical path difference compensation element disposed between the light combining and splitting element and the second light path adjustment element, and a tilt angle is present between an optical axis of the optical path difference compensation element and the third direction, the tilt angle is between 2 degrees and 30 degrees.

3. The projection device according to claim 2, wherein the lighting system further comprises a light homogenizing element disposed between the optical path difference compensation element and the light combining and splitting element.

4. The projection device according to claim 1, wherein the lighting system further comprises a diffusion sheet disposed between the light source module and the first light path adjustment element.

5. The projection device according to claim 1, further comprising a quarter-wave plate disposed between the light combining and splitting element and the wavelength conversion assembly, wherein the light combining and splitting element is a polarized coating beam splitter, and the light combining and splitting element is configured to allow the light source beam transmitted along the second direction to pass through and the light combining and splitting element is configured to reflect the conversion light beam.

6. The projection device according to claim 1, wherein the wavelength conversion assembly comprises a wavelength selection element and a wavelength conversion element, wherein:
the wavelength selection element is disposed between the wavelength conversion element and the light combining and splitting element, the wavelength selection element has a reflection zone and a wavelength selection zone, the reflection zone and the wavelength selection zone enter the transmission path of the light source beam at different points in time, and the reflection zone is configured to reflect the light source beam and to transmit the light source beam to the light combining and splitting element and the light valve assembly; and
the wavelength conversion element converts the at least part of the light source beam passing through the wavelength selection zone into the conversion light beam and enables at least part of the conversion light beam to pass through the wavelength selection zone.

7. The projection device according to claim 6, wherein the wavelength conversion assembly further comprises a drive element connected to the wavelength selection element and the wavelength conversion element, the wavelength selection element and the wavelength conversion element are stacked, and the drive element is configured to drive the wavelength selection element and the wavelength conversion element to rotate synchronously.

8. The projection device according to claim 6, wherein the wavelength conversion assembly further comprises a lens assembly and a first drive element, the lens assembly is disposed between the wavelength selection element and the wavelength conversion element, and the first drive element is configured to drive the wavelength selection element to rotate.

9. The projection device according to claim 8, wherein the wavelength conversion assembly further comprises a second drive element configured to drive the wavelength conversion element to rotate.

10. The projection device according to claim 1, wherein the lighting system further comprises a light homogenizing element disposed between the second light path adjustment element and the light combining and splitting element, the light homogenizing element is a microlens array, the light combining and splitting element comprises a first optical portion and a second optical portion, the first optical portion is configured to allow the light source beam to pass through and the first optical portion is configured to reflect the conversion light beam, and the second optical portion is configured to reflect the conversion light beam.

11. The projection device according to claim 1, wherein the light source module is configured to further provide an auxiliary light beam along the first direction, the first light path adjustment element is disposed on the transmission path of the auxiliary light beam and configured to transmit the auxiliary light beam along the second direction, the light combining and splitting element is suitable for passing the auxiliary light beam transmitted along the second direction.

12. The projection device according to claim 11, wherein the wavelength conversion assembly comprises a wavelength selection element and a wavelength conversion element, wherein:
the wavelength selection element is disposed between the wavelength conversion element and the light combining and splitting element, the wavelength selection element has a reflection zone and a wavelength selection zone, the reflection zone and the wavelength selection zone enter the transmission path of the light source beam at different points in time, and the wavelength selection zone is configured to reflect the auxiliary light beam, to pass the light source beam, and to transmit the auxiliary light beam to the light combining and splitting element and the light valve assembly.
